(19) United States
(12) Patent Application Publication
(10) Pub. No.: US 2026/0272055 A1
(43) Pub. Date: Sep. 17, 2026

(54) ELECTRONIC AEROSOL PROVISION SYSTEM

(71) Applicant: Nicoventures Trading Limited, 1 Water Street (GB)

(72) Inventors: Jocelyn Benning, London (GB); Kelly Rees, London (GB); Walid Abi Aoun, London (GB)

(21) Appl. No.: 19/667,161

(22) Filed: May 4, 2026

Related U.S. Application Data
(63) Continuation of application No. 17/780,374, filed on Nov. 27, 2020.

(30) Foreign Application Priority Data
Nov. 29, 2019 (GB) 1917452.3

(51) Int. Cl. A24F 40/57; A24F 40/46; A24F 40/60

(52) U.S. Cl. CPC A24F 40/57; A24F 40/46; A24F 40/60

(57) ABSTRACT

An aerosol provision system for generating aerosol from an aerosol generating material. The system comprises one or more portions of solid aerosol generating material having a mass no greater than 20 mg, and 5 wt % to 80 wt % aerosol generating agent, 1 wt % to 60 wt % gelling agent, and less than 15 mg water; one or more aerosol generating components; and control circuitry configured to supply power to the one or more aerosol generating components. The control circuitry is configured to cause heating of at least one of the one or more portions of aerosol generating material using the one or more aerosol generating components at an operational temperature at which aerosol is generated from the at least one of the one or more portions of aerosol generating material of no greater than 350° C. for a continuous duration of no greater than 10 seconds.

### RELATED APPLICATIONS

The present application is a Continuation of U.S. patent application Ser. No. 17/780,374, filed May 26, 2022; which is a National Phase entry of PCT Application No. PCT/EP2020/083784, filed Nov. 27, 2020; which claims priority from GB Patent Application No. 1917452.3, filed Nov. 29, 2019, which is hereby fully incorporated herein by reference.

### FIELD

The present disclosure relates to non-combustible aerosol provision systems.

### BACKGROUND

Electronic aerosol provision systems such as electronic cigarettes (e-cigarettes) generally contain a reservoir of a source liquid containing a formulation, typically including nicotine, from which an aerosol is generated, e.g., through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Other aerosol provision devices generate aerosol from a solid material, such as tobacco or a tobacco derivative. Such devices operate in a broadly similar manner to the liquid-based systems described above, in that the solid tobacco material is heated to a vaporization temperature to generate an aerosol which is subsequently inhaled by a user.

Consistent puff-by-puff experiences, e.g., those that do not vary on a puff-by-puff basis, can be difficult to implement using the above systems, and as such the user may not be provided with an overall consistent experience.

Various approaches are described which seek to help address some of these issues.

### SUMMARY

According to a first aspect of certain embodiments there is provided an aerosol provision system for generating aerosol from an aerosol generating material, the system comprising: one or more portions of solid aerosol generating material, each portion of solid aerosol generating material having a mass no greater than 20 mg, and comprising aerosol generating agent in an amount of from about 5 wt % to 80 wt % and gelling agent in an amount of from about 1 wt % to 60 wt %, wherein these weights are calculated on a dry weight basis, and less than 15 mg water; one or more aerosol generating components; and control circuitry configured to supply power to the one or more aerosol generating components, wherein the control circuitry is configured to cause heating of at least one of the one or more portions of aerosol generating material using the one or more aerosol generating components at an operational temperature at which aerosol is generated from the at least one of the one or more portions of aerosol generating material of no greater than 350° C. for a continuous duration of no greater than 10 seconds.

According to a second aspect of certain embodiments there is provided an aerosol provision device for generating aerosol from one or more portions of solid aerosol generating material, each portion of solid aerosol generating material having a mass of no greater than 20 mg, and comprising aerosol generating agent in an amount of from about 5 wt % to 80 wt % and gelling agent in an amount of from about 1 wt % to 60 wt %, wherein these weights are calculated on a dry weight basis, and less than 15 mg water, the device comprising: one or more aerosol generating components configured to aerosolize one or more portions of aerosol generating material; and control circuitry configured to supply power to the one or more aerosol generating components, wherein the control circuitry is configured to cause heating of at least one of the one or more portions of aerosol generating material using the one or more aerosol generating components at an operational temperature at which aerosol is generated from the at least one of the one or more portions of aerosol generating material of no greater than 350° C. for a continuous duration of no greater than 10 seconds.

According to a third aspect of certain embodiments there is provided a method for generating aerosol from one or more portions of aerosol generating material using one or more aerosol generating components, wherein each portion of solid aerosol generating material has a mass of no greater than 20 mg, and comprising aerosol generating agent in an amount of from about 5 wt % to 80 wt % and gelling agent in an amount of from about 1 wt % to 60 wt %, wherein these weights are calculated on a dry weight basis, and less than 15 mg water, the method comprising: heating of at least one of the one or more portions of aerosol generating material using one or more aerosol generating components at an operational temperature at which aerosol is generated from the at least one of the one or more portions of aerosol generating material of no greater than 350° C. for a continuous duration of no greater than 10 seconds.

According to a fourth aspect of certain embodiments there is provided an aerosol provision system for generating aerosol from an aerosol generating material, the system comprising: one or more portions of solid aerosol generating material, each portion of solid aerosol generating material having a mass of no greater than 20 mg, and comprising aerosol generating agent in an amount of from about 5 wt % to 80 wt % and gelling agent in an amount of from about 1 wt % to 60 wt %, wherein these weights are calculated on a dry weight basis, and less than 15 mg water; one or more aerosol generating means; and control means configured to supply power to the one or more aerosol generating means, wherein the control means is configured to cause heating of at least one of the one or more portions of aerosol generating material using the one or more aerosol generating means at an operational temperature at which aerosol is generated from the at least one of the one or more portions of aerosol generating material of no greater than 350° C. for a continuous duration of no greater than 10 seconds.

It will be appreciated that features and aspects of the disclosure described above in relation to the first and other aspects of the disclosure are equally applicable to, and may be combined with, embodiments of the disclosure according to other aspects of the disclosure as appropriate, and not just in the specific combinations described above.

### BRIEF DESCRIPTION OF THE DRAWINGS

Embodiments of the disclosure will now be described, by way of example only, with reference to the accompanying drawings, in which:

FIG. 1 is a cross-section of a schematic representation of an aerosol provision system comprising an aerosol provision device and an aerosol generating article, the device comprising a plurality of heating elements and the article comprising a plurality of portions of aerosol generating material.

FIGS. 2A to 2C are a variety of views from different angles of the aerosol provision article of FIG. 1.

FIG. 3 is cross-sectional, top-down view of the heating elements of the aerosol provision device of FIG. 1.

FIG. 4 is a top-down view of an exemplary touch sensitive panel for operating various functions of the aerosol provision system.

FIG. 5 is a graph showing exemplary amounts of instantaneous aerosol generated in two separate heating phases A and B using the device of FIG. 1.

FIG. 6 is a flow chart showing a method of generating aerosol in accordance with the principles of the present disclosure.

FIG. 7 is an example of a cross-section of a schematic representation of an aerosol provision system comprising an aerosol provision device and an aerosol generating article, the device comprising a plurality of induction work coils and the article comprising a plurality of portions of aerosol generating material and corresponding susceptor portions.

FIGS. 8A to 8C are a variety of views from different angles of the aerosol provision article of FIG. 7.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to a “non-combustible” aerosol provision system. A “non-combustible” aerosol provision system is one where a constituent aerosolizable material of the aerosol provision system (or component thereof) is not combusted or burned in order to facilitate delivery of an aerosol to a user. Furthermore, and as is common in the technical field, the terms “vapor” and “aerosol”, and related terms such as “vaporize”, “volatilize” and “aerosolize”, may generally be used interchangeably.

In some implementations, the non-combustible aerosol provision system is an electronic cigarette, also known as a vaping device or electronic nicotine delivery system (END), although it is noted that the presence of nicotine in the aerosolizable material is not a requirement. Throughout the following description the term “e-cigarette” or “electronic cigarette” is sometimes used but this term may be used interchangeably with aerosol (vapor) provision system.

Typically, the non-combustible aerosol provision system may comprise a non-combustible aerosol provision device and an article (sometimes referred to as a consumable) for use with the non-combustible aerosol provision device. However, it is envisaged that articles which themselves comprise a means for powering an aerosol generating component may themselves form the non-combustible aerosol provision system.

The article, part or all of which, is intended to be consumed during use by a user. The article may comprise or consist of aerosolizable material. The article may comprise one or more other elements, such as a filter or an aerosol modifying substance (e.g. a component to add a flavor to, or otherwise alter the properties of, an aerosol that passes through or over the aerosol modifying substance).

Non-combustible aerosol provision systems often, though not always, comprise a modular assembly including both a reusable aerosol provision device and a replaceable article. In some implementations, the non-combustible aerosol provision device may comprise a power source and a controller (or control circuitry). The power source may, for example, be an electric power source, such as a battery or rechargeable battery. In some implementations, the non-combustible aerosol provision device may also comprise an aerosol generating component. However, in other implementations the article may comprise partially, or entirely, the aerosol generating component.

In some implementations, the aerosol generating component is a heater capable of interacting with the aerosolizable material so as to release one or more volatiles from the aerosolizable material to form an aerosol. In some embodiments, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

The article for use with the non-combustible aerosol provision device generally comprises an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine or flavorant. In the following disclosure, the aerosolizable material is described as comprising an “amorphous solid”, which may alternatively be referred to as a “monolithic solid” (e.g. non-fibrous). In some implementations, the amorphous solid may be a dried gel. The amorphous solid is a solid material that may retain some fluid, such as liquid, within it. In some implementations, the aerosolizable material may for example comprise from about 50 wt %, 60 wt % or 70 wt % of amorphous solid, to about 90 wt %, 95 wt % or 100 wt % of amorphous solid. However, it should be appreciated that principles of the present disclosure, where applicable, may be applied to other aerosolizable materials, such as tobacco, reconstituted tobacco, a liquid, such as an e-liquid, etc.

As appropriate, the aerosolizable material may comprise any one or more of: an active constituent, a carrier constituent, a flavor, and one or more other functional constituents.

The active constituent as used herein may be a physiologically active material, which is a material intended to achieve or enhance a physiological response. The active constituent may for example be selected from nutraceuticals, nootropics, psychoactives. The active constituent may be naturally occurring or synthetically obtained. The active constituent may comprise for example nicotine, caffeine, taurine, theine, vitamins such as B6 or B12 or C, melatonin, cannabinoids, or constituents, derivatives, or combinations thereof. The active constituent may comprise one or more constituents, derivatives or extracts of tobacco, cannabis or another botanical. As noted herein, the active constituent may comprise one or more constituents, derivatives or extracts of cannabis, such as one or more cannabinoids or terpenes.

In some embodiments, the active constituent comprises nicotine. In some embodiments, the active constituent comprises caffeine, melatonin or vitamin B12.

As noted herein, the active constituent may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens.

In some embodiments, the active constituent comprises or is derived from one or more botanicals or constituents, derivatives or extracts thereof and the botanical is tobacco. In some embodiments, the active constituent comprises or derived from one or more botanicals or constituents, derivatives or extracts thereof and the botanical is selected from eucalyptus, star anise, cocoa and hemp.

In some embodiments, the active constituent comprises or derived from one or more botanicals or constituents, derivatives or extracts thereof and the botanical is selected from rooibos and fennel.

In some implementations, the aerosolizable material comprises a flavor (or flavorant).

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint or peppermint. In some embodiments, the flavor comprises flavor components of cucumber, blueberry, citrus fruits or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The carrier constituent may comprise one or more constituents capable of forming an aerosol. In some embodiments, the carrier constituent may comprise one or more of glycerin, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the carrier constituent comprises one or more polyhydric alcohols, such as propylene glycol, triethylene glycol, 1,3-butanediol and glycerin; esters of polyhydric alcohols, such as glycerol mono-, di- or triacetate; or aliphatic esters of mono-, di- or polycarboxylic acids, such as dimethyl dodecanedioate and dimethyl tetradecanedioate. The one or more other functional constituents may comprise one or more of pH regulators, coloring agents, preservatives, binders, fillers, stabilizers, or antioxidants.

The aerosolizable material may also comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid may be particularly advantageous in embodiments in which the aerosolizable material comprises nicotine. In such embodiments, the presence of an acid may stabilize dissolved species in the slurry from which the aerosolizable material is formed. The presence of the acid may reduce or substantially prevent evaporation of nicotine during drying of the slurry, thereby reducing loss of nicotine during manufacturing.

In some embodiments, the aerosolizable material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosolizable material may comprise one or more cannabinoid compounds selected from the group consisting of cannabidiol (CBD) and THC (tetrahydrocannabinol). The aerosolizable material may comprise cannabidiol (CBD).

The aerosolizable material may comprise nicotine and cannabidiol (CBD).

The aerosolizable material may comprise nicotine, cannabidiol (CBD), and THC (tetrahydrocannabinol).

The aerosolizable material may be present on or in a carrier support (or carrier component) to form a substrate. The carrier support may, for example, be or comprise paper, card, paperboard, cardboard, reconstituted aerosolizable material, a plastics material, a ceramic material, a composite material, glass, a metal, or a metal alloy.

In some implementations, the article for use with the non-combustible aerosol provision device may comprise aerosolizable material or an area for receiving aerosolizable material. In some implementations, the article for use with the non-combustible aerosol provision device may comprise a mouthpiece, or alternatively the non-combustible aerosol provision device may comprise a mouthpiece which communicates with the article. The area for receiving aerosolizable material may be a storage area for storing aerosolizable material. For example, the storage area may be a reservoir.

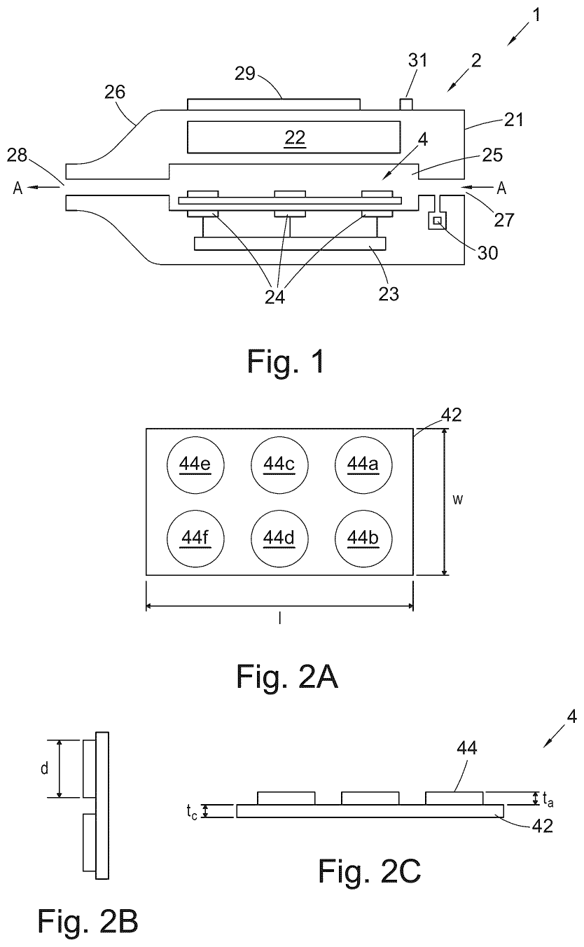

FIG. 1 is a cross-sectional view through a schematic representation of an aerosol provision system 1 in accordance with certain embodiments of the disclosure. The aerosol provision system 1 comprises two main components, namely an aerosol provision device 2 and an aerosol generating article 4.

The aerosol provision device 2 comprises an outer housing 21, a power source 22, control circuitry 23, a plurality of aerosol generating components 24, a receptacle 25, a mouthpiece end 26, an air inlet 27, an air outlet 28, a touch-sensitive panel 29, an inhalation sensor 30, and an end of use indicator 31.

The outer housing 21 may be formed from any suitable material, for example a plastics material. The outer housing 21 is arranged such that the power source 22, control circuitry 23, aerosol generating components 24, receptacle 25 and inhalation sensor 30 are located within the outer housing 21. The outer housing 21 also defines the air inlet 27 and air outlet 28, described in more detail below. The touch sensitive panel 29 and end of use indicator are located on the exterior of the outer housing 21.

The outer housing 21 further includes a mouthpiece end 26. The outer housing 21 and mouthpiece end 26 are formed as a single component (that is, the mouthpiece end 26 forms a part of the outer housing 21). The mouthpiece end 26 is defined as a region of the outer housing 21 which includes the air outlet 28 and is shaped in such a way that a user may comfortably place their lips around the mouthpiece end 26 to engage with air outlet 28. In FIG. 1, the thickness of the outer housing 21 decreases towards the air outlet 28 to provide a relatively thinner portion of the device 2 which may be more easily accommodated by the lips of a user. In other implementations, however, the mouthpiece end 26 may be a removable component that is separate from but able to be coupled to the outer housing 21, and may be removed for cleaning or replacement with another mouthpiece end 26.

The power source 22 is configured to provide operating power to the aerosol provision device 2. The power source 22 may be any suitable power source, such as a battery. For example, the power source 22 may comprise a rechargeable battery, such as a Lithium Ion battery. The power source 22 may be removable or form an integrated part of the aerosol provision device 2. In some implementations, the power source 22 may be recharged through connection of the device 2 to an external power supply (such as mains power) through an associated connection port, such as a USB port (not shown) or via a suitable wireless receiver (not shown).

The control circuitry 23 is suitably configured/programmed to control the operation of the aerosol provision device to provide certain operating functions of aerosol provision device 2. The control circuitry 23 may be considered to logically comprise various sub-units/circuitry elements associated with different aspects of the aerosol provision devices' operation. For example, the control circuitry 23 may comprise a logical sub-unit for controlling the recharging of the power source 22. Additionally, the control circuitry 23 may comprise a logical sub-unit for communication, e.g., to facilitate data transfer from or to the device 2. However, a primary function of the control circuitry 23 is to control the aerosolization of aerosol generating material, as described in more detail below. It will be appreciated the functionality of the control circuitry 23 can be provided in various different ways, for example using one or more suitably programmed programmable computer(s) and/or one or more suitably configured application-specific integrated circuit(s)/circuitry/chip(s)/chipset(s) configured to provide the desired functionality. The control circuitry 23 is connected to the power supply 23 and receives power from the power source 22 and may be configured to distribute or control the power supply to other components of the aerosol provision device 2.

In the described implementation, the aerosol provision device 2 further comprises a receptacle 25 which is arranged to receive an aerosol generating article 4.

The aerosol generating article 4 comprises a carrier component 42 and aerosol generating material 44. The aerosol generating article 4 is shown in more detail in FIGS. 2A to 2C. FIG. 2A is a top-down view of the article 4, FIG. 2B is an end-on view along the longitudinal (length) axis of the article 4, and FIG. 2C is a side-on view along the width axis of the article 4.

The article 4 comprises a carrier component 42 which in this implementation is formed of card. The carrier component 42 forms the majority of the article 4, and acts as a base for the aerosol generating material 44 to be deposited on.

The carrier component 42 is broadly cuboidal in shape has a length 1, a width w and a thickness t_{c} as shown in FIGS. 2A to 2C. By way of a concrete example, the length of the carrier component 42 may be 30 to 80 mm, the width may be 7 to 25 mm, and the thickness may be between 0.2 to 1 mm. However, it should be appreciated that the above are exemplary dimensions of the carrier component 42, and in other implementations the carrier component 42 may have different dimensions as appropriate. In some implementations, the carrier component 42 may comprise one or more protrusions extending in the length or width directions of the carrier component 42 to help facilitate handling of the article 4 by the user.

In the example shown in FIGS. 1 and 2, the article 4 comprises a plurality of discrete portions of aerosol generating material 44 disposed on a surface of the carrier component 42. More specifically, the article 4 comprises six discrete portions of aerosol generating material 44, labelled 44a to 44f, disposed in a two by three array. However, it should be appreciated that in other implementations a greater or lesser number of discrete portions may be provided, or the portions may be disposed in a different array (e.g., a one by six array). In the example shown, the aerosol generating material 44 is disposed at discrete, separate locations on a single surface of the component carrier 42. The discrete portions of aerosol generating material 44 are shown as having a circular footprint, although it should be appreciated that the discrete portions of aerosol generating material 44 may take any other footprint, such as square or rectangular, as appropriate. The discrete portions of aerosol generating material 44 have a diameter d and a thickness ta as shown in FIGS. 2A to 2C. The thickness ta may take any suitable value, for example the thickness ta may be in the range of 50 μm to 1.5 mm. In some embodiment, the thickness ta is from about 50 μm to about 200 μm, or about 50 μm to about 100 μm, or about 60 μm to about 90 μm, suitably about 77 μm. In other embodiments, the thickness ta may be greater than 200 μm, e.g., from about 50 μm to about 400 μm, or to about 1 mm, or to about 1.5 mm.

The discrete portions of aerosol generating material 44 are separate from one another such that each of the discrete portions may be energized (e.g., heated) individually/selectively to produce an aerosol. In some implementations, the portions of aerosol generating material 44 may have a mass no greater than 20 mg, such that the amount of material to be aerosolized by a given aerosol generating component 24 at any one time is relatively low. For example, the mass per portion may be equal to or lower than 20 mg, or equal to or lower than 10 mg, or equal to or lower than 5 mg. Of course, it should be appreciated that the total mass of the article 4 may be greater than 20 mg.

In the described implementation, the aerosol generating material 44 is an amorphous solid. Generally, the amorphous solid may comprise a gelling agent (sometimes referred to as a binder) and an aerosol generating agent (which might comprise glycerol, for example). Optionally, the aerosol generating material may comprise one or more of the following: an active substance (which may include a tobacco extract), a flavorant, an acid, and a filler. Other components may also be present as desired. Suitable active substances, flavorant, acids and fillers are described above in relation to the aerosolizable material.

Thus the aerosol generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the aerosol generating agent comprises one or more polyhydric alcohols, such as propylene glycol, triethylene glycol, 1,3-butanediol and glycerin; esters of polyhydric alcohols, such as glycerol mono-, di- or triacetate; or aliphatic esters of mono-, di- or polycarboxylic acids, such as dimethyl dodecanedioate and dimethyl tetradecanedioate.

In some embodiments, the gelling agent comprises a hydrocolloid. In some embodiments, the gelling agent comprises one or more compounds selected from the group comprising alginates, pectins, starches (and derivatives), celluloses (and derivatives, such as such as methylcellulose, hydroxypropyl cellulose, and carboxymethyl cellulose (CMC)), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum, guar gum, carrageenan, agarose, acacia gum, fumed silica, PDMS, sodium silicate, kaolin and polyvinyl alcohol.

The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In embodiments, the non-cellulose based gelling agent is alginate or agar.

The aerosol-generating material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid may be particularly advantageous in embodiments in which the aerosol-generating material comprises nicotine. In such embodiments, the presence of an acid may stabilize dissolved species in the slurry from which the aerosol-generating material is formed. The presence of the acid may reduce or substantially prevent evaporation of nicotine during drying of the slurry, thereby reducing loss of nicotine during manufacturing.

In certain embodiments, the aerosol-generating material comprises a gelling agent comprising a cellulosic gelling agent or a non-cellulosic gelling agent, an active substance and an acid.

In some embodiments, the aerosol-generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol-generating material may comprise one or more cannabinoid compounds selected from the group consisting of cannabidiol (CBD) and THC (tetrahydrocannabinol).

The aerosol-generating material may comprise cannabidiol (CBD).

The aerosol-generating material may comprise nicotine and cannabidiol (CBD).

The aerosol-generating material may comprise nicotine, cannabidiol (CBD), and THC (tetrahydrocannabinol).

The amorphous solid may comprise a colorant. The addition of a colorant may alter the visual appearance of the amorphous solid. The presence of colorant in the amorphous solid may enhance the visual appearance of the amorphous solid and the aerosol-generating material. By adding a colorant to the amorphous solid, the amorphous solid may be color-matched to other components of the aerosol-generating material or to other components of an article comprising the amorphous solid.

A variety of colorants may be used depending on the desired color of the amorphous solid. The color of amorphous solid may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosol-generating material comprising the amorphous solid. In some embodiments, the addition of a colorant to the amorphous solid renders it visually indistinguishable from other components in the aerosol-generating material.

The colorant may be incorporated during the formation of the amorphous solid (e.g. when forming a slurry comprising the materials that form the amorphous solid) or it may be applied to the amorphous solid after its formation (e.g. by spraying it onto the amorphous solid).

In some embodiments, the amorphous solid comprises tobacco extract. In these embodiments, the amorphous solid may have the following composition (by Dry Weight Basis, DWB): gelling agent (e.g., comprising alginate) in an amount of from about 1 wt % to about 60 wt %, or about 10 wt % to 30 wt %, or about 15 wt % to about 25 wt %; tobacco extract in an amount of from about 10 wt % to about 60 wt %, or from about 40 wt % to 55 wt %, or from about 45 wt % to about 50 wt %; aerosol generating agent (e.g., comprising glycerol) in an amount of from about 5 wt % to about 60 wt %, or from about 20 wt % to about 40 wt %, or from about 25 wt % to about 35 wt % (DWB). The tobacco extract may be from a single variety of tobacco or a blend of extracts from different varieties of tobacco. Such amorphous solids may be referred to as “tobacco amorphous solids”, and may be designed to deliver a tobacco-like experience when aerosolized.

In one embodiment, the amorphous solid comprises about 20 wt % alginate gelling agent, about 48 wt % Virginia tobacco extract and about 32 wt % glycerol (DWB).

The amorphous solid of these embodiments may have any suitable water content. For example, the amorphous solid may have a water content of from about 5 wt % to about 15 wt %, or from about 7 wt % to about 13 wt %, or about 10 wt %.

Suitably, in any of these embodiments, the amorphous solid has a thickness ta of from about 50 μm to about 200 μm, or about 50 μm to about 100 μm, or about 60 μm to about 90 μm, suitably about 77 μm.

In some implementations, the amorphous solid may comprise 0.5-60 wt % of a gelling agent; and 5-80 wt % of an aerosol generating agent, wherein these weights are calculated on a dry weight basis. Such amorphous solids may contain no flavor, no acid and no active substance. Such amorphous solids may be referred to as “aerosol generating agent rich” or “aerosol generating agent amorphous solids”. More generally, this is an example of an aerosol generating agent rich aerosol generating material which, as the name suggests, is a portion of aerosol generating material which is designed to deliver aerosol generating agent when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB).

In some other implementations, the amorphous solid may comprise 0.5-60 wt % of a gelling agent; 5-80 wt % of an aerosol generating agent; and 1-60 wt % of a flavor, wherein these weights are calculated on a dry weight basis. Such amorphous solids may contain flavor, but no active substance or acid. Such amorphous solids may be referred to as “flavorant rich” or “flavor amorphous solids”. More generally, this is an example of a flavorant rich aerosol generating material which, as the name suggests, is a portion of aerosol generating material which is designed to deliver flavorant when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), flavor in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 5-60 wt % of at least one active substance, wherein these weights are calculated on a dry weight basis. Such amorphous solids may contain an active substance, but no flavor or acid. Such amorphous solids may be referred to as “active substance rich” or “active substance amorphous solids”. For example, in one implementation, the active substance may be nicotine, and as such an amorphous solid as described above comprising nicotine may be referred to as a “nicotine amorphous solid”. More generally, this is an example of an active substance rich aerosol generating material which, as the name suggests, is a portion of aerosol generating material which is designed to deliver an active substance when aerosolized.

In these implementations, amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), active substance in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 0.1-10 wt % of an acid, wherein these weights are calculated on a dry weight basis. Such amorphous solids may contain acid, but no active substance and flavorant. Such amorphous solids may be referred to as “acid rich” or “acid amorphous solids”. More generally, this is an example of an acid rich aerosol generating material which, as the name suggests, is a portion of aerosol generating material which is designed to deliver an acid when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), acid in an amount of from about 0.1 wt % to about 8 wt %, or from about 0.5 wt % to 7 wt %, or from about 1 wt % to about 5 wt %, or form about 1 wt % to about 3 wt %.

Referring back to FIG. 1, the receptacle 25 is suitable sized to removably receive the article 4 therein. Although not shown, the device 2 may comprise a hinged door or removable part of the outer housing 21 to permit access to the receptacle 25 such that a user may insert or remove the article 4 from the receptacle 25. The hinged door or removable part of the outer housing 21 may also act to retain the article 4 within the receptacle 25 when closed. When the aerosol generating article 4 is exhausted or the user simply wishes to switch to a different aerosol generating article 4, the aerosol generating article 4 may be removed from the aerosol provision device 2 and a replacement aerosol generating article 4 positioned in the receptacle 25 in its place. Alternatively, the device 2 may include a permanent opening that communicates with the receptacle 25 and through which the article 4 can be inserted into the receptacle 25. In such implementations, a retaining mechanism for retaining the article 4 within the receptacle 25 of the device 2 may be provided.

As seen in FIG. 1, the device 2 comprises a number of aerosol generating components 24. In the described implementation, the aerosol generating components 24 are heating elements 24, and more specifically resistive heating elements 24. Resistive heating elements 24 receive an electrical current and convert the electrical energy into heat. The resistive heating elements 24 may be formed from, or comprise, any suitable resistive heating material, such as NiChrome (Ni20Cr80), which generates heat upon receiving an electrical current. In one implementation, the heating elements 24 may comprise an electrically insulating substrate on which resistive tracks are disposed.

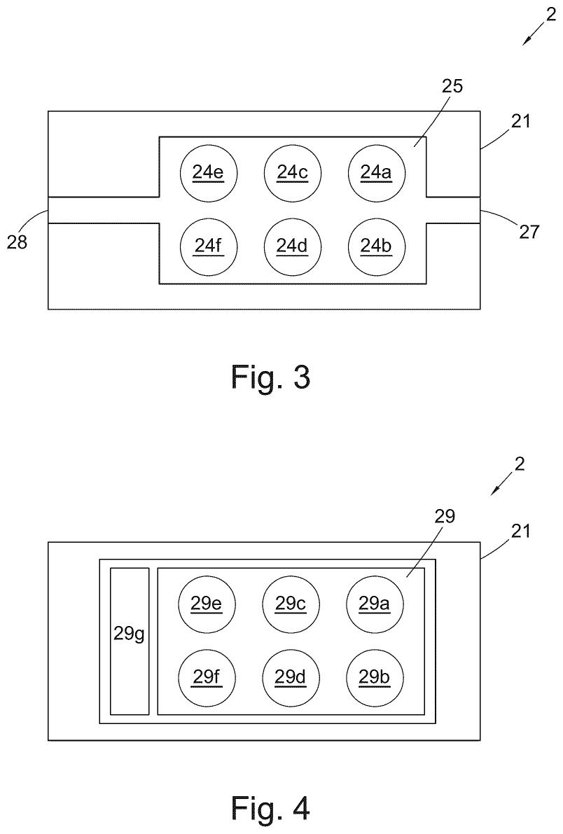

FIG. 3 is a cross-sectional, top-down view of the aerosol provision device 2 showing the arrangement of the heating elements 24 in more detail. In FIGS. 1 and 3, the heating elements 24 are positioned such that a surface of the heating element 24 forms a part of the surface of the receptacle 25. That is, an outer surface of the heating elements 24 is flush with the inner surface of the receptacle. More specifically, the outer surface of the heating element 24 that is flush with the inner surface of the receptacle 25 is a surface of the heating element 24 that is heated (e.g., its temperature increases) when an electrical current is passed through the heating element 24.

In the present example, the heating element 24 is formed of an electrically-conductive plate, which defines the surface of the heating element that is arranged to increase in temperature. The electrically-conductive plate may be formed of a metallic material, for example, NiChrome, which generates heat when a current is passed through the electrically-conductive plate. In other implementations, a separate electrically-conductive track may pass on a surface of, or through, a second material (e.g., a metal material or a ceramic material), with the electrically-conductive track generating heat that is transferred to the second material. That is, the second material in combination with the electrically-conductive track form the heating element 24. In the latter example, the surface of the heating element that is arranged to increase in temperature is defined by the perimeter of the second material.

In the described implementation, the surfaces of the heating elements 24 that are arranged to increase in temperature are also planar and are generally located in a plane parallel to the wall of the receptacle 25. However, in other implementations, the surfaces may be curved; that is to say, the plane in which the surfaces of the heating elements 24 are located may have a radius of curvature in one axis (e.g., the surface may be approximately parabolic). The heating elements 24 are arranged such that, when the article 4 is received in the receptacle 25, each heating element 24 aligns with a corresponding discrete portion of aerosol generating material 44. Hence, in this example, six heating elements 24 are arranged in a two by three array broadly corresponding to the arrangement of the two by three array of the six discrete portions of aerosol generating material 44 shown in FIGS. 2A to 2C. However, as discussed above, the number of heating elements 24 may be different in different implementations, for example there may be 8, 10, 12, 14, etc. heating elements 24. In some implementations, the number of heating elements 24 is greater than or equal to six but no greater than 20.

More specifically, the heating elements 24 are labelled 24a to 24f in FIG. 3, and it should be appreciated that each heating element 24 is arranged to align with a corresponding portion of aerosol generating material 44 as denoted by the corresponding letter following the references 24/44. Accordingly, each of the heating elements 24 can be individually activated to heat a corresponding portion of aerosol generating material 44.

While the heating elements 24 are shown flush with the inner surface of the receptacle 25, in other implementations the heating elements 24 may protrude into the receptacle 25. In either case, the article 4 contacts the surfaces of the heating elements 24 when present in the receptacle 25 such that heat generated by the heating elements 24 is conducted to the aerosol generating material 44 through the carrier component 42.

In some implementations, to improve the heat-transfer efficiency, the receptacle may comprise components which apply a force to the surface of the carrier component 42 so as to press the carrier component 42 onto the heater elements 24, thereby increasing the efficiency of heat transfer via conduction to the aerosol generating material 44. Additionally or alternatively, the heater elements 24 may be configured to move in the direction towards/away from the article 4, and may be pressed into the surface of carrier component 42 that does not comprise the aerosol generating material 44.

In use, the device 2 (and more specifically the control circuitry 23) is configured to deliver power to the heating elements 24 in response to a user input. Broadly speaking, the control circuitry 23 is configured to selectively apply power to the heating elements 24 to subsequently heat the corresponding portions of aerosol generating material 44 to generate aerosol. When a user inhales on the device 2 (e.g., inhales at mouthpiece end 26), air is drawn into the device 2 through air inlet 27, into the receptacle 25 where it mixes with the aerosol generated by heating the aerosol generating material 44, and then to the user's mouth via air outlet 28. That is, the aerosol is delivered to the user through mouthpiece end 26 and air outlet 28.

The device 2 of FIG. 1 includes a touch-sensitive panel 29 and an inhalation sensor 30. Collectively, the touch-sensitive panel 29 and inhalation sensor 30 act as mechanisms for a receiving a user input to cause the generation of aerosol, and thus may more broadly be referred to as user input mechanisms. The received user input may be said to be indicative of a user's desire to generate aerosol.

The touch-sensitive panel 29 may be a capacitive touch sensor and can be operated by a user of the device 2 placing their finger or another suitably conductive object (for example a stylus) on the touch-sensitive panel. In the described implementation, the touch-sensitive panel includes a region which can be pressed by a user to start aerosol generation. The control circuitry 23 may be configured to receive signaling from the touch-sensitive panel 29 and to use this signaling to determine if a user is pressing (e.g. activating) the region of the touch-sensitive panel 29. If the control circuitry 23 receives this signaling, then the control circuitry 23 is configured to supply power from the power source 22 to one or more of the heating elements 24. Power may be supplied for a predetermined time period (for example, three seconds) from the moment a touch is detected, or in response to the length of time the touch is detected for. In other implementations, the touch sensitive panel 29 may be replaced by a user actuatable button or the like.

The inhalation sensor 30 may be a pressure sensor or microphone or the like configured to detect a drop in pressure or a flow of air caused by the user inhaling on the device 2. The inhalation sensor 30 is located in fluid communication with the air flow pathway (that is, in fluid communication with the air flow path between inlet 27 and outlet 28). In a similar manner as described above, the control circuitry 23 may be configured to receive signaling from the inhalation sensor and to use this signaling to determine if a user is inhaling on the aerosol provision system 1. If the control circuitry 23 receives this signaling, then the control circuitry 23 is configured to supply power from the power source 22 to one or more of the heating elements 24. Power may be supplied for a predetermined time period (for example, three seconds) from the moment inhalation is detected, or in response to the length of time the inhalation is detected for.

In the described example, both the touch-sensitive panel 29 and inhalation sensor 30 detect the user's desire to begin generating aerosol for inhalation. The control circuitry 23 may be configured to only supply power to the heating element 24 when signaling from both the touch-sensitive panel 29 and inhalation sensor 30 are detected. This may help prevent inadvertent activation of the heating elements 24 from accidental activation of one of the user input mechanisms. However, in other implementations, the aerosol provision system 1 may have only one of a touch sensitive panel 29 and an inhalation sensor 30.

These aspects of the operation of the aerosol provision system 1 (e.g. puff detection and touch detection) may in themselves be performed in accordance with established techniques (for example using conventional inhalation sensor and inhalation sensor signal processing techniques and using conventional touch sensor and touch sensor signal processing techniques).

In the described implementation, in response to detecting the signaling from either one or both of the touch-sensitive panel 29 and inhalation sensor 30, the control circuitry 23 is configured to sequentially supply power to each of the individual heating elements 24.

More specifically, the control circuitry 23 is configured to sequentially supply power to each of the individual heating elements 23 in response to a sequence of detections of the signaling received from either one or both of the touch-sensitive panel 29 and inhalation sensor 30. For example, the control circuitry 23 may be configured to supply power to a first heating element 24 of the plurality of heating elements 24 (e.g., heating element 24a) when the signaling is first detected (e.g., from when the device 2 is first switched on). When the signaling stops, or in response to the predetermined time from the signaling being detected elapsing, the control circuitry 23 registers that the first heating element 24a has been activated (and thus the corresponding portion of aerosol generating material 44a has been heated). The control circuitry 23 determines that in response to receiving subsequent signaling from either one or both of the touch-sensitive panel 29 and inhalation sensor 30 that a second heating element 24, e.g., heating element 24b, is to be activated. Accordingly, when the signaling from either one or both of the touch-sensitive panel 29 and inhalation sensor 30 is received by the control circuitry 23, the control circuitry 23 activates the second heating element 24b to cause heating of the portion of aerosol generating material 44b. This process is repeated for remaining heating elements 24, such that all heating elements 24 are sequentially activated.

Effectively, this operation means that for each inhalation, a different one of the discrete portions of aerosol generating material 44 is heated and an aerosol generated therefrom. In other words, a single discrete portion of aerosol generating material is heated per user inhalation.

Such sequential activations may be dubbed “a sequential activation mode”, which is primarily designed to deliver a consistent aerosol per inhalation (which may be measured in terms of total aerosol generated, or a total constituent delivered, for example). Hence, this mode may be most effective when each portion of the aerosol generating material 44 of the aerosol generating article 4 is substantially identical; that is, portions 44a to 44f are formed of the same material and have substantially the same properties.

In some other implementations, in response to detecting the signaling from either one or both of the touch-sensitive panel 29 and inhalation sensor 30, the control circuitry 23 is configured to supply power to one or more of the heating elements 24 simultaneously.

In such implementations, the control circuitry 23 may be configured to supply power to selected ones of the heating elements 24 in response to a predetermined configuration. The predetermined configuration may be a configuration selected or determined by a user. For example, the touch-sensitive panel 29 may comprise a region that permits the user to individually select which of the heating elements 24 to activate when signaling from either one or both of the touch-sensitive panel 29 and inhalation sensor 30 is received by the control circuitry 23. In some implementations, the user may also be able to set the power level for each heating element 24 to be supplied to heating element 24 in response to receiving the signaling.

FIG. 4 is a top-down view of the touch-sensitive panel 29 in accordance with such implementations. FIG. 4 schematically shows outer housing 21 and touch-sensitive panel 29 as described previously. The touch-sensitive panel 29 comprises six regions 29a to 29f which correspond to each of the six heating elements 24, and a region 29g which corresponds to the region for indicating that a user wishes to start inhalation or generating aerosol as described previously. The six regions 29a to 29f each correspond to touch-sensitive regions which can be touched by a user to control the power delivery to each of the six corresponding heating elements 24. In the described implementation, each heating element 24 can have multiple states, e.g., an off state in which no power is supplied to the heating element 24, a low power state in which a first level of power is supplied to the heating element 24, and a high power state in which a second level of power is supplied to the heating element 24 where the second level of power is greater than the first level of power. However, in other implementations, fewer or greater states may be available to the heating elements 24. For example, each heating element 24 may have an off state in which no power is supplied to the heating element 24 and an on state in which power is supplied to the heating element 24.

Accordingly, a user can set which heating elements 24 (and subsequently which portions of aerosol generating material 44) are to be heated (and optionally to what extent they are to be heated) by interacting with the touch-sensitive panel 29 in advance of generating aerosol. For example, the user may repeatedly tap the regions 29a to 29f to cycle through the different states (e.g., off, low power, high power, off, etc.). Alternatively, the user may press and hold the region 29a to 29f to cycle through the different states, where the duration of the press determines the state.

The touch-sensitive panel 29 may be provided with one or more indicators for each of the respective regions 29a to 29f to indicate which state the heating element 24 is currently in. For example, the touch-sensitive panel may comprise one or more LEDs or similar illuminating elements, and the intensity of the LEDs signifies the current state of the heating element 24. Alternatively, a colored LED or similar illuminating element may be provided and the color indicates the current state. Alternatively, the touch-sensitive panel 29 may comprise a display element (e.g., which may underlie a transparent touch-sensitive panel 29 or be provided adjacent to the regions 29a to 29f of the touch-sensitive panel 29) which displays the current state of the heating element 24.

When the user has set the configuration for the heating elements 24, in response to detecting the signaling from either one or both of the touch-sensitive panel 29 (and more particularly region 29g of touch-sensitive panel 29) and inhalation sensor 30, the control circuitry 23 is configured to supply power to the selected heating elements 24 in accordance with the pre-set configuration.

Accordingly, such simultaneous heating element 24 activations may be dubbed “a simultaneous activation mode”, which is primarily designed to deliver a customizable aerosol from a given article 4, with the intention of allowing a user to customize their experience on a session-by-session or even puff-by-puff basis. Hence, this mode may be most effective when portions of the aerosol generating material 44 of the aerosol generating article 4 are different from one another. For example, portions 44a and 44b are formed of one material, portions 44c and 44d are formed of a different material, etc. Accordingly, with this mode of operation, the user may select which portions to aerosolize at any given moment and thus which combinations of aerosols to be provided with.

In accordance with an aspect of the present disclosure, an advantageous aerosol provision system 1 is achieved when the aerosol provision system is arranged such that relatively small portions of solid aerosol generating material 44 are heated by a corresponding heating element 24 for a continuous duration corresponding to a user inhalation.

More specifically, the aerosol provision system 1 comprises one or more portions of solid aerosol generating material 44, where each portion of solid aerosol generating material 44 has a mass no greater than 20 mg, and comprises aerosol generating agent in an amount of from about 5 wt % to 80 wt % and gelling agent in an amount of from about 1 wt % to 60 wt % (wherein these weights are calculated on a dry weight basis) and comprises less than 15 mg water. In addition, the aerosol provision system 1 comprises one or more aerosol generating components (e.g., heating elements) 24 and control circuitry 23 configured to supply power to the one or more aerosol generating components 24. The control circuitry 23 is configured to cause heating of at least one of the one or more portions of aerosol generating material using the one or more aerosol generating components 24 at an operational temperature of no greater than 350° C. for a continuous duration of no greater than 10 seconds.

Accordingly, an aerosol provision system 1 which comprises solid aerosol generating material 44 (which may be disposed on or in the carrier component 42) can help to reduce or even eradicate problems of leakage more commonly associated with liquid aerosol generating materials (for example, as with some conventional e-cigarettes). Using a solid aerosol generating material reduces the chances of aerosol generating material leaking from the article 4 or device 2 when the article 4 is installed in the device 2. It should be appreciated, however, that use of a solid aerosol generating material may not significantly impact the “leaking” of condensed aerosol which is formed when the aerosol generated by heating aerosol generating material (solid or liquid) condenses on the inner surfaces of the device 2 and subsequently flows out of the device 2.

In particular, the solid aerosol generating material in accordance with the present disclosure comprises an aerosol generating agent (such as glycerol) in an amount of from about 5 wt % to 80 wt % and gelling agent (such as alginate) in an amount of from about 1 wt % to 60 wt %. Aerosol generating agent is provided for a number of reasons. The aerosol generating agent is provided to enable visible aerosol to be generated such that the greater the amount of aerosol generating agent provided, the greater the volume of visible vapor generated. Additionally, the aerosol generating agent can help provide a certain user experience. For example, when a relative large amount of aerosol generating agent is aerosolized, the aerosol feels heavier/more bodied when inhaled. Further, the aerosol generating agent also acts as a transport mechanism for other constituents that may be provided in the aerosol generating material, e.g., nicotine or flavorant. Providing the aerosol generating agent in an amount of from about 5 wt % to 80 wt % has been found to be particularly suitable, although it should be appreciated that certain ones of the functions that the aerosol generating agent can fulfil may be prioritized over other functions in certain implementations. Gelling agent is provided to provide a solid foundation or structure for the aerosol generating material, which can be used to help hold other constituents (such as the glycerol) within the aerosol generating material. It has been found that an amount of from about 1 wt % to 60 wt % is particularly suitable. The aerosol generating material may comprise other constituents as appropriate and as detailed above.

Some conventional devices which heat a solid (or approximately solid) aerosol generating material, such as reconstituted tobacco, are known. However, these devices tend to heat a substantial quantity of aerosol generating material (e.g., on the order of 300 to 500 mg) continuously for a prolonged period of time (e.g., on the order of minutes). Heating a larger mass using a relatively small heating element (as in, a heating element which is suitable to be inserted in a portable hand-held device) means that the heating element is switched on (and thus using power) for the entire duration of use. In some cases, this is referred to as a session of use and typically includes a number of user inhalations that is similar to the number of inhalations required to smoke a cigarette (e.g., between 8 to 12).

However, by reducing the mass of the solid portion of aerosol generating material 44 to be heated by a given heating element 24 to 20 mg or less, the total energy used during a session to deliver aerosol can be reduced.

In accordance with principles of the present disclosure, each portion of solid aerosol generating material that is to be heated may have a mass selected from the group comprising: less than 20 mg, less than 15 mg, less than 10 mg, less than 5 mg, and less than 4 mg. Broadly speaking, the lower the total mass per portion of aerosol generating material, the less energy is required to raise the (average) temperature of the aerosol generating material to a target temperature at which aerosol may be generated.

In addition, and as described in the above, the aerosol provision device 2 can be configured to heat discrete portions of solid aerosol generating material in response to a user's desire to inhale aerosol. As described above, in some implementations, the control circuitry 23 is configured to heat a portion of solid aerosol generating material per inhalation.

In accordance with the present disclosure, the control circuitry 23 is configured to cause heating of a given portion of aerosol generating material having a mass of no greater than 20 mg to generate an aerosol for a continuous duration of no greater than 10 seconds. On the one hand, this is made possible by the fact that the portion of aerosol generating material has a mass of no greater than 20 mg. As mentioned, the total energy required to raise a portion of aerosol generating material to a given temperature to generate aerosol is dependent on the mass of that portion of aerosol generating material. It has been found that sufficient energy can be supplied from a power source 22 such as battery during a period of 10 seconds or less to generate a sufficient aerosol (e.g., a sufficient quantity of aerosol suitable for user inhalation) when the mass of the portion of aerosol generating material is no greater than 20 mg. On the other hand, the energy efficiency of the system 1 can be improved by only causing heating of the aerosol generating material 44 to a temperature sufficient to generate aerosol during periods which broadly correspond in length and time to a typical user inhalation. A typical user inhalation may be on the order of 3 to 5 seconds, but it should be appreciated that this may vary depending upon the construction (and associated airflow) of the aerosol provision system 1 or the individual user (e.g., their lung capacity, etc.). That is, it has been found that the temperature of the solid aerosol generating material can be raised from a lower temperature and which aerosol is not generated to a temperature sufficient to generate a sufficient quantity of aerosol from the aerosol generating material within a period not exceeding 10 seconds, when the mass of the aerosol generating material is no greater than 20 mg. In particular implementations, this is for a handheld, portable aerosol provision system in which typical battery capacity and output are similar to current electronic cigarette devices. Accordingly, the control circuitry 23 can be configured to perform heating sufficient to generate an aerosol from a solid aerosol generating material only for periods during which the user is inhaling, e.g., for periods of less than 10 consecutive seconds.

As described above, in some implementations, the heating elements 24 may be activated for a predetermined length of time from the moment signaling indicating a user's desire to inhale is received from either one or both of the touch-sensitive panel 29 and inhalation sensor 30. That is, the control circuitry 23 may be arranged to stop the supply of power sufficient to cause aerosolization of the portion of aerosol generating material after the predetermined time period has elapsed. The predetermined time period is a duration no greater than 10 seconds. In other implementations, the predetermined time period may be between 1 to 9 seconds, between 1.5 to 7 seconds, or between 2 to 5 seconds.

Alternatively or additionally, the control circuitry 23 may stop supplying power sufficient to cause aerosolization of the portion of aerosol generating material when the signaling indicating a user's desire to inhale aerosol stops (e.g., when the signaling from the inhalation sensor 30 or touch sensitive element 29 is stopped because the user stops inhaling or stops pressing the touch sensitive element 29). In these implementations, while in principle power sufficient to cause aerosolization of a portion of aerosol generating material can be provided for a duration longer than 10 consecutive seconds, the control circuitry 23 is configured to stop supplying power sufficient to cause aerosolization of the portion of aerosol generating material after a predetermined time of no longer than 10 seconds has elapsed. This may be implemented to prevent burning/charring/overheating of the aerosol generating material. Accordingly, in much the same way as above, the predetermined time period is a duration no greater than 10 seconds, and in other implementations, the predetermined time period may be between 1 to 9 seconds, between 1.5 to 7 seconds, or between 2 to 5 seconds.

It should be appreciated that, in some implementations, the aerosol provision system 1 may be arranged to heat a given portion of aerosol generating material to generate aerosol for a total cumulative time of greater than 10 seconds. However, in accordance with the principles of the present disclosure, each time the control circuitry 23 causes heating of a portion of aerosol generating material to generate aerosol, the control circuitry 23 does so for no more than 10 consecutive seconds. In other words, each time the control circuitry 23 causes heating of a portion of aerosol generating material to generate aerosol for a period of time, a period of the control circuitry 23 not causing heating of a portion of aerosol generating material to generate aerosol immediately proceeds this period of time. Hence, in some implementations, the same portion of aerosol generating material may be heated for eight inhalations, for example. If each inhalation is three seconds, then the portion of aerosol generating material may be heated for three seconds on eight separate occasions to generate aerosol for a cumulative duration of 24 seconds.

It should be appreciated that, in some instances, power may be supplied to the heating element(s) 24 using pulse width modulation (PWM), which is a process where power is supplied in pulses and the time between pulses determines the average power supplied per unit of time. When the control circuitry 23 causes heating of a portion of aerosol generating material to generate aerosol, the level of power to cause such heating may be supplied continuously or intermittently (e.g., pulsed) provided that the average power supplied is sufficient to raise the temperature of the heating element to an operational temperature at which aerosol can be generated.

Accordingly, by supplying power sufficient to cause aerosolization of a solid portion of aerosol generating material having a mass of no greater than 20 mg only for a period of time which broadly corresponds to the duration of a typical inhalation, the energy usage of the system can be reduced compared to aerosol provision devices that heat a greater mass of solid aerosol generating material for a prolonged time. Even if the energy/power required to raise the heating element 24 from a low/ambient temperature to an operational temperature is larger compared to the power required to maintain a heating element at an operational temperature, energy/power is not supplied during the periods of non-inhalation. Thus, assuming a session of ten inhalations of three seconds each over a period of three minutes, power sufficient to cause aerosolization is supplied for around one sixth of the session length according to the aerosol provision system of the present disclosure.

Moreover, providing an aerosol provision system 1 according to the above enables the user to use the aerosol provision system to “graze” on the aerosol generating material 44/article 4. That is, the user may use the aerosol provision system 1 as and when is desired as opposed to using the system 1 within a certain time period. In particular, the user may use the system 1 to inhale aerosol, wait ten minutes for example, and then use the system 1 to inhale aerosol again. Such a mode of operation is not as energy efficient when heating a larger mass of aerosol generating material as mentioned above, and in some cases, this operation may result in poorer performance over time with respect to the amounts of the deliverable constituents that are delivered to the user per inhalation.

In addition, and as described above, each portion of solid aerosol generating material has a total water content of less than 15 mg. In some implementations, each portion of solid aerosol generating material has a water content selected from the group comprising: less than 25 wt %, less than 20 wt %, less than 15 wt %, less than 10 wt % and less than 7 wt %, where all weights are calculated on a dry weight basis. In some implementations, the total water content for a plurality of portions of aerosol generating material which are to be heated at substantially the same time is less than 15 mg. If the water content of the aerosol generating material is too high, its performance in use is compromised. The high heat capacity of water means that if the water content is too high, more energy is needed to generate an aerosol, reducing operating efficiency. Further, if the water content is too high, the puff profile may be less satisfactory to the consumer due to the generation of hot and humid puffs (a sensation known in the field as “hot puff”). In particular, aerosolizing more than 15 mg for a given inhalation gives rise to hot puff as detectable by a user. Thus, limiting the amount of water content to less than 15 mg reduces or eliminates the occurrence of hot puff.

In the described implementations, the control circuitry 23 is configured to supply power to the heating elements 24 only in response to the signaling received from either one or both of the touch-sensitive panel 29 and inhalation sensor 30. That is, no power is supplied to the heating elements 24 in the absence of the signaling or if the predetermined time period has elapsed. When power is supplied, the power supplied is sufficient to cause aerosolization of the aerosol generating material. In particular, the power supplied may cause the heating element 24 to reach an aerosol generation temperature whereby the aerosol generation temperature is sufficient to cause aerosolization of at least a part of the aerosol generating material.

The actual value of the aerosol generation temperature may depend on the type of aerosol generating material that is being heated. Additionally, the aerosol generation temperature may be a range of temperatures at which the aerosol generating material can generate a detectable (and in particular, user perceivable) aerosol. The target temperature (which may also be referred to as the operational temperature) is a temperature that the control circuitry 23 causes the heating element to reach to generate an aerosol. The operational temperature may therefore be one or more fixed values selected from the range of aerosol generating temperatures. In most implementations, the operational temperature is selected from the group comprising: between 150° C. to 350° C., between 180° C. to 320° C., and between 220° C. to 300° C. In accordance with the principles of the present disclosure, however, the control circuitry is configured such that the operational temperature is no greater than 350° C. For most suitable aerosol generating materials, heating to above 350° C. significantly increases the possibility of charring or burning the aerosol generating material, which can lead to unpleasant or off-tastes being generated in the aerosol or may lead to other undesirable constituents being released.

In some implementations, the aerosol generating material is an amorphous solid. Examples of amorphous solids are described above, and any or a combination of these may be used in accordance with the present disclosure. An amorphous solid aerosolizable material offers some advantages over other types of aerosolizable materials commonly found in some electronic aerosol provision devices. For example, compared to electronic aerosol provision devices which aerosolize a solid aerosolizable material, e.g., tobacco, a comparably lower mass of amorphous solid material can be aerosolized to generate an equivalent amount of aerosol (or to provide an equivalent amount of a constituent in the aerosol, e.g., nicotine). This is in part due to the fact that an amorphous solid can be tailored to not include unsuitable constituents that might be found in other solid aerosolizable materials (e.g., cellulosic material in tobacco, for example). That is, amorphous solids offer the advantage to provide relatively concentrated quantities of material/constituents desired to be released in an aerosol as compared to some other aerosol generating materials, such as tobacco. This enables relatively smaller portions of the amorphous solid to be used (and subsequently heated) as compared to other solid materials such as tobacco. Accordingly, the overall energy efficiency of the system can be improved while providing substantially similar amounts of aerosol or constituents as, generally speaking, less energy is required to raise a smaller mass to a given temperature.

In some implementations, the control circuitry 23 may be configured to supply power to one or more heating elements outside of receiving signaling indicating the user's desire to inhale aerosol. For example, the control circuitry 23 may supply power between discrete inhalations. In these scenarios, the level of power is less than that required to generate detectable aerosol (and in particular user perceivable) aerosol. For instance, the level of power supplied may be sufficient to raise the temperature of the heating element to a temperature below which the aerosol generating material generates aerosol. This temperature may be referred to as a preheat (or pre-heat) temperature. As with the operational temperature above, the preheat temperature may be one or more fixed values selected from the range of temperatures below the aerosol generating temperature. The preheat temperature or range of preheat temperatures will also vary depending upon the material that is to be aerosolized and may be selected to be below the aerosol generation temperature. For example, the preheat temperature may be 150° C. or less. Accordingly, the control circuitry 23 may be configured to cause preheating of a portion of aerosol generating material at the preheating temperature prior to receiving signaling from either one or both of the touch-sensitive panel 29 and inhalation sensor 30 indicating the user's desire to inhale aerosol. When the signaling is received, the control circuitry 23 causes the heating element 23 to be raised to the operational temperature for a duration of no longer than 10 seconds. After the duration of no longer than 10 seconds has elapsed, the control circuitry 23 may stop supplying power or supply power sufficient to cause the temperature of the heating element to reach the preheating temperature. In instances where the sequential mode of operation is utilized, the control circuitry 23 may sequentially heat each of the portions of aerosol generating material by performing preheating followed by heating at the operational temperature. These processes may be staggered for sequential portions of aerosol generating material, e.g., preheating for the portion of aerosol generating material next in the sequence may be performed during or after the current aerosol generating material in the sequence is being heated at the operational temperature.

Using a preheating process can provide a balance between a reduced energy consumption required for aerosolizing the aerosol generating material and the speed of generating an aerosol when receiving signaling indicating the user's desire to inhale aerosol. For example, if the rate at which the aerosol generating material reaches the operational temperature is relatively slow (e.g., due to the thickness of the aerosol generating material or the composition of the material), then preheating can reduce the time needed to reach the operational temperature as the aerosol generating material is at an elevated temperature prior to being heated to the operational temperature. This arrangement is still considered to be more energy efficient than heating at the operational temperature for the entire session of use.

While it has been described above that the rate at which the aerosol generating material reaches a temperature sufficient to cause aerosolization of a sufficient amount of material during a period of no greater than 10 seconds is dependent on the mass of the portion, it should be appreciated that other parameters may also affect the rate at which the aerosol generating material reaches a temperature sufficient to cause aerosolization of a sufficient amount of material. For example, the thickness ta of the aerosol generating material may be in the range of 50 μm to 1.5 mm. In some embodiments, the thickness ta is from about 50 μm to about 200 μm, or about 50 μm to about 100 μm, or about 60 μm to about 90 μm, suitably about 77 μm. In other embodiments, the thickness ta may be greater than 200 μm, e.g., from about 50 μm to about 400 μm, or to about 1 mm, or to about 1.5 mm. Additionally, the areal extent of a portion of aerosol generating material may also affect the rate at which the aerosol generating material reaches a temperature sufficient to cause aerosolization of a sufficient amount of material. The areal extent of the portion of aerosol generating material may be no greater than 130 mm². In some implementations, the areal extent of the portion of aerosol generating material is between 30 mm² to 130 mm². In other implementations, the areal extent of the portion of aerosol generating material is between 35 to 80 mm², or between 40 to 75 mm². As described above, the area of a given heating element 24 may correspond to the areal extent of the corresponding portion of aerosol generating material.

As should be appreciated from the above, the aerosol provision system 1 may be configured to generate an aerosol having a desired amount of one or more constituent components (or a total amount of aerosol) when heated at the operational temperature for a predetermined continuous time not exceeding 10 seconds. The way in which this is achieved will depend on the specifics of the system. As described above the skilled person will be well aware that by altering the mass of the aerosol generating material, the thickness of the aerosol generating material, the areal extent of the portions of aerosol generating material, the composition of the aerosol generating material or the operational temperature within the bounds as described above will provide a sufficient amount of aerosol.

Additionally, as described above, the aerosol provision system 1 comprises a plurality of portions of aerosol generating material. For each of these portions of aerosol generating material, the control circuitry 23 is configured to cause heating of each of the plurality of portions of aerosol generating material using the one or more aerosol generating components at an operational temperature of no greater than 350° C. for a continuous duration of no greater than 10 seconds. This can help ensure that each portion of aerosol generating material is heated in a way that means sufficient aerosol for user inhalation is generated. Each portion of aerosol generating material may be the same or different from one another, and each portion of aerosol generating material may be heated the same or differently from one another.

In some particular implementations, an aerosol provision system designed to aerosolize individual portions of aerosol generating material per puff, and under the same conditions per puff, with each portion having substantially the same composition and dimensions, can lead to an inhalation session (e.g., a series of user inhalations) having a good level of consistency throughout the inhalation session. That is, each inhalation is substantially identical in terms of the amount of aerosol generated from each of the individual portions of aerosol generating material. In this regard, each of the portions of aerosol generating material may be substantially the same as one another. In some implementations, each of the portions of aerosol generating material may be the same as one another. As before, each portion of solid aerosol generating material has a mass no greater than 20 mg, and comprises aerosol generating agent in an amount of from about 5 wt % to 60 wt % and gelling agent in an amount of from about 1 wt % to 60 wt %, wherein these weights are calculated on a dry weight basis, and less than 15 mg water, and the control circuitry is configured to cause heating of at least one of the one or more portions of aerosol generating material using the one or more aerosol generating components at an operational temperature of no greater than 350° C. for a continuous duration of no greater than 10 seconds.

Each of the portions of aerosol generating material being substantially the same as one another as used herein means that the portions of aerosol generating material have the same constituent components and the quantities thereof vary by no more than a small percentage from the average quantity, e.g., by 10% or less, or 5% or less, or 2% or less. That is, the chemical formulation is substantially the same for each portion of aerosol generating material. That is, each portion of aerosol generating material has a quantity of a given constituent within a small error margin compared to the average quantity for that component over all portions of the aerosol generating material. By way of example only, suppose the average content of a gelling agent within the aerosol generating material is 0.5 mg, then each portion of aerosol generating material may have a quantity of gelling agent which is 0.5 mg±0.05 mg.

Each of the portions of aerosol generating material being substantially the same as one another as used herein also means that the portions of aerosol generating material have the same physical parameters and these parameters vary by no more than a small percentage from the average quantity, e.g., by 10% or less, or 5% or less, or 2% or less. That is, the physical properties of each portion of aerosol generating material are substantially the same. The physical properties may include, but are not limited to: the thickness of the portion; the length, width, diameter, or any other suitable measurement of the portion; and the shape of the portion.

In addition, the device 2 is configured such that the heating elements 24 (or more generally the one or more aerosol generating components 24) are substantially the same as one another. In some implementations, each of the one or more aerosol generating components may be the same as one another.

In this regard, the heating elements 24 being substantially the same as one another means that the heating elements 24 have the same physical dimensions, for example the same shape, the same exposed surface area (which may be the surface designed to heat during use), etc. Again, as discussed above in respect of the physical characteristics of the aerosol generating material, these parameters vary by no more than a small percentage from the average value, e.g., by 10% or less, or 5% or less, or 2% or less. The heating elements 24 being substantially the same as one another also means that the heating elements 24 are formed from the same materials and have the same basic construction. For example, the heating elements 24 may be formed from a metallic plate (or another heat conductive material) and have an electrical trace disposed on one surface (the surface facing away from the receptacle 25 for example) which is configured to heat up when an electrical current is passed through the trace.

In addition, the control circuitry 23 is configured to cause heating of the heating elements 24 (or more generally operation of the aerosol generating components 24) to provide substantially the same operational characteristics. In some implementations, the operation of each of the aerosol generating components 24 may be the same as one another.

For example, in the case of a resistive heating element 24 as described above, the control circuitry 23 is configured to supply the same power over the course of the same heating duration to the respective heating elements 24. For example, the control circuitry 23 may be configured to apply say 5 Watts over a heating period to the operational temperature of three seconds, although it should be appreciated that these numbers are purely given by way of example only. Again, as discussed above, these parameters governing the operational characteristics may vary by no more than a small percentage from the average value, e.g., by 10% or less, or 5% or less, or 2% or less. The control circuitry 23 may also apply the same changes in power delivery over the same heating period, if applicable. For example, the control circuitry 23 may apply 8 Watts for one second, followed by 5 Watts for the remaining two seconds.

In this way, whenever a heating element 24 is activated to cause subsequent aerosolization of a corresponding portion of aerosol generating material 44, substantially the same conditions are applied irrespective of whether the portion of aerosol generating material being aerosolized is the first in the session, in the middle of the session, or at the end of the session. Accordingly, substantially the same amount, or the same amount, of aerosol can be generated from each portion of aerosol generating material with each activation (corresponding to a user's desire to inhale aerosol). Therefore, the device 2 is configured to consistently generate aerosol for each activation, such that a user may experience a consistent or substantially consistent experience during each inhalation.

As described above, in some implementations, the heating duration may be variable depending upon the length of user's inhalation. In these implementations, an inconsistency may occur between puffs in a session simply due to the user's variation in puff length. However, the device 2 is nevertheless configured to provide consistent delivery for a given standard inhalation. That is, for two puffs of identical duration, the device 2 is configured to generate a consistent amount of aerosol for these two identical puffs. One can test this parameter for a given device 2 using the Coresta Recommended Method 81, CRM 81, for example, and collecting and analyzing the generated aerosol mass.

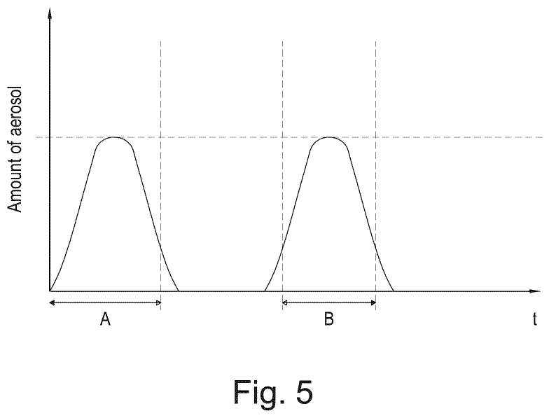

FIG. 5 is an example graph demonstrating the principles of the present disclosure. The graph shows the instantaneous aerosol amount generated (y-axis) as a function of time (x-axis). The graph is exemplary only and the shapes of the curves may be different from that shown when measured using a practical system. Equally, no values for the measurements are given on the graph for the same reasons.

FIG. 5 shows two heating element activation phases, labelled A and B in FIG. 5. The duration of the heating element activation phases A and B are substantially the same. The duration generally corresponds to an expected user's inhalation and may be on the order of 2 to 5 seconds, and in accordance with the present disclosure will be no longer than 10 seconds.

As shown, the heating element activation phases are discrete and sequential. Heating element activation phase A may, for example, correspond to heating element 24a while heating element activation phase B may correspond to heating element 24b. The device 2 is therefore configured to activate one heating element 24 at any one time, and as discussed above, is configured to activate the heating elements 24 sequentially to sequentially aerosolize the respective portions of aerosol generating material.

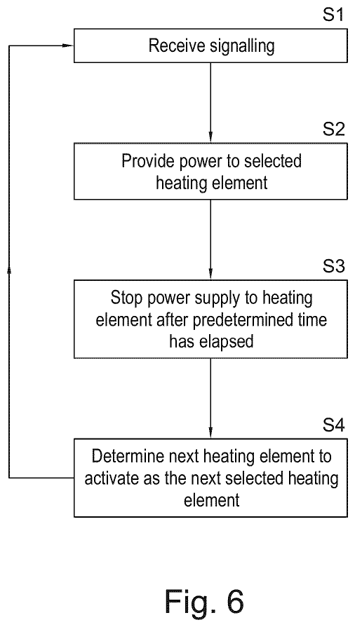

FIG. 6 is a flow diagram showing an exemplary method of aerosol generation in accordance with the present disclosure.

The method starts at step S1 where the control circuitry 23 is configured to receive a signal signifying a user's intent to generate aerosol (e.g., from either one or both of the touch-sensitive panel 29 and the inhalation sensor 30).

At step S2, in response to receiving the signal, the control circuitry 23 is configured to cause aerosolization of a first portion of the aerosol generating material, for example portion 44a.

At step S3, the control circuitry 23, in this implementation, is configured to stop causing aerosolization of the portion 44a once the pre-determined duration for the heating element activation phase A has elapsed. As seen in FIG. 5, this may not necessarily stop aerosol generation as residual heat in the heating element 24 may cause a small amount of aerosol to continue to be generated after the power supply to the heating element is stopped.

The method then proceeds to step S4 where the control circuitry 23 determines the next heating element 24 to be heated, e.g., heating element 24b. (Although steps S4 is shown as between step S3 and S4, it should be appreciated that step S4 may be implemented between steps S1 and S2 in other implementations).

At this point, the method proceeds back to step S1 where the control circuitry 23 receives a subsequent signal signifying a user's intent to generate aerosol after aerosolizing the first portion of aerosol generating material (portion 44a), and in response thereto, at step S2 cause aerosolization, in this instance, of a second portion of the aerosol generating material, for example portion 44b. At step S3, the control circuitry 23, in this implementation, is configured to stop causing aerosolization of the portion 44b once the pre-determined duration for the heating element activation phase B has elapsed.

This process may be repeated for all of the portions of aerosol generating material (e.g., 44c, 44d, 44e, and 44f).

Accordingly, as seen in FIG. 5, the instantaneous aerosol generated when heating a first portion of aerosol generating material 44a is substantially the same for any given moment in time of the heating phase A as compared to a similar heating phase B in which a second portion of aerosol generating material 44b is heated. In this way, a consistent amount of aerosol can be generated from each portion of aerosol generating material 44, thus helping to improve the overall consistency experienced by a user during use of the device 2.

As described, the device 2 is configured to generate substantially the same amount of aerosol per puff for a given puff. With reference to FIG. 5, when referring to substantially the same amount of aerosol generated per activation, this may mean one or both of: the total amount of aerosol generated per puff (e.g., the integral of each curve in FIG. 5), and the maximum amount of aerosol generated per second per puff (e.g., the horizontal dashed line indicated in FIG. 5). In essence, when the operating conditions are substantially the same as described above, then both the amount of aerosol generated per puff and the maximum amount of aerosol generated per second per puff will be substantially the same.

As mentioned, the control circuitry 23 is configured to generate aerosol from the respective portions of aerosol generating material by applying the same operational conditions to the aerosol generating components. That is, the control circuitry 23 is configured to output the same set of instructions or the same control signals to control the power delivery to the aerosol generating components 24 regardless of which aerosol generating component 24 is to be aerosolized. For example, the control circuitry 23 may control the power source 22 to deliver the same power, for example. In the case of a plurality of heating elements 24 as the aerosol generating components, the control circuitry 23 may be configured to heat each heating element 24 using substantially the same temperature profile (that is, the change of temperature of the heating element 24 with time). Assuming the operating conditions are substantially the same, the control circuitry 23 may adhere to this simply by outputting the same control signals, etc. as mentioned above. However, in some cases, the control circuitry 23 may monitor the temperature of the heating element 24 and if the temperature is not in conformity with an expected or pre-set temperature profile, the control circuitry 23 may be configured to alter the power delivery to the heating element to ensure the expected temperature profile is met.

In some implementations, the control circuitry 23 is configured to begin heating each of the plurality of portions of aerosol generating material when the heating element 24 is substantially at ambient temperature or the same preheating temperature. For example, the control circuitry 23 may monitor the temperatures of each of the heating elements 24 and select a heating element 24 to apply power to which is substantially at ambient temperature or a given preheating temperature. This may be particularly relevant for the second (or later) activation in a session when a previous heating element 24 may have already been activated within receptacle 25 and thus cause a change in the temperature of adjacent heating elements. Accordingly, the control circuitry 23 can ensure that the heating conditions are substantially the same for each heating element 24 to provide better consistency in the amount of aerosol generated per puff as described above.

In some implementations, the control circuitry 23 may monitor the temperature of the heating elements 24, e.g., via a separate temperature sensor, to determine which heating element 24 to activate next in the sequence. Other ways of measuring the temperature of the heating elements 24, e.g., via measuring an electrical property of the heating element 24, may also be employed in accordance with the principles of the present disclosure.

Additionally or alternatively, to help ensure that the initial conditions before heating are as consistent as possible for subsequent activations of heating elements 24, the control circuitry 23 is configured to select a heating element that is spatially further away from a current (or previously heated) heating element than the spatially closest heating element as the next heating element in the heating sequence. For example, with reference to FIG. 3, suppose the current heating element is 24a. The spatially closest heating elements to heating element 24a are heating elements 24b and 24c. That is, the distance between the center of the exposed surface of heating element 24a and heating element 24b is approximately the same as the distance between the center of the exposed surface of heating element 24a and heating element 24c, and this distance is smaller than the distances to any other of the heating elements, e.g., 24d, 24e, and 24f. Hence, by way of example only, the control circuitry 23 may set the sequence of heating elements to be activated as: heating element 24a, heating element 24d, heating element 24e, heating element 24b, heating element 24c, and finally heating element 24f. This is merely an example sequence using the arrangement of heating elements 24 shown in FIG. 3. Other heating element sequences may be used in accordance with the described principles (and equally the sequences may be different when there are a large number of heating elements). Selecting a next heating element to activate in the sequence that is spatially further away from the closest heating elements helps to reduce the influence of heat bleed on the starting temperature of the next heating element to be activated in the sequence from the current (or previous) activation of the current (or previous) heating element.

In some implementations, the aerosol generating material is an amorphous solid as described above. It has been found that such an amorphous solid is particularly suited to giving a consistent user experience as the proportions of and types of the constituents used to form the amorphous solids can be accurately controlled during the formation of the amorphous solid. In other words, manufacturing tolerances on the formulations or physical properties of the amorphous solid can be made very low.

In the implementation described in FIG. 1, in the sequential activation mode, the control circuitry 23 may be configured to generate an alert signal which signifies the end of use of the article 4, for example when each of the heating elements 24 has been sequentially activated a predetermined number of times, or when a given heating element 24 has been activated a predetermined number of times or for a given cumulative activation time or with a given cumulative activation power. In FIG. 1, the device 2 includes an end of use indicator 31 which in this implementation is an LED. However, in other implementations, the end of use indicator 31 may comprise any mechanism which is capable of supplying an alert signal to a user; that is, the end of use indicator 31 may be an optical element to deliver an optical signal, a sound generator to deliver an aural signal, or a vibrator to deliver a haptic signal. In some implementations, the indicator 31 may be combined or otherwise provided by the touch-sensitive panel (e.g., if the touch-sensitive panel includes a display element). The device 2 may prevent subsequent activation of the device 2 when the alert signal is being output. The alert signal may be switched off, and the control circuitry 23 reset, when the user replaces the article 4 or switches off the alert signal via a manual means such as a button (not shown).

In more detail, in implementations where the sequential mode of activation is employed, the control circuitry 23 may be configured to count the number of times signaling from either one or both of the touch-sensitive panel 29 and inhalation sensor 30 is received during a period of usage, and once the count reaches a predetermined number, the article 4 is determined to reach the end of its life. For example, for an article 4 comprising six discrete portions of aerosol generating material 44, the predetermined number may be six, twelve, eighteen, etc. depending on the exact implementation at hand.

The above technique for determining the end of life of the article 4 should not be understood as a limiting way of determining the end of life of the article 4, and in fact any other suitable way may be employed in accordance with the principles of the present disclosure.

Although it has been described above that each portion of aerosol generating material is substantially the same as any other on the article 4, it should be appreciated that in some implementations the article 4 may comprise sets of portions of aerosol generating material, for example six portions of one material and six portions of another material, where each portion of the set of aerosol generating material is substantially the same within the set but may be different between sets. In these articles 4, devices 2 may be designed to offer a choice between aerosolizing one set of aerosol generating material or the other set; however, one set of the aerosol generating material may be aerosolized for a given inhalation session (e.g., of between 6 to 20 inhalations), such that consistent aerosol is produced for that session.

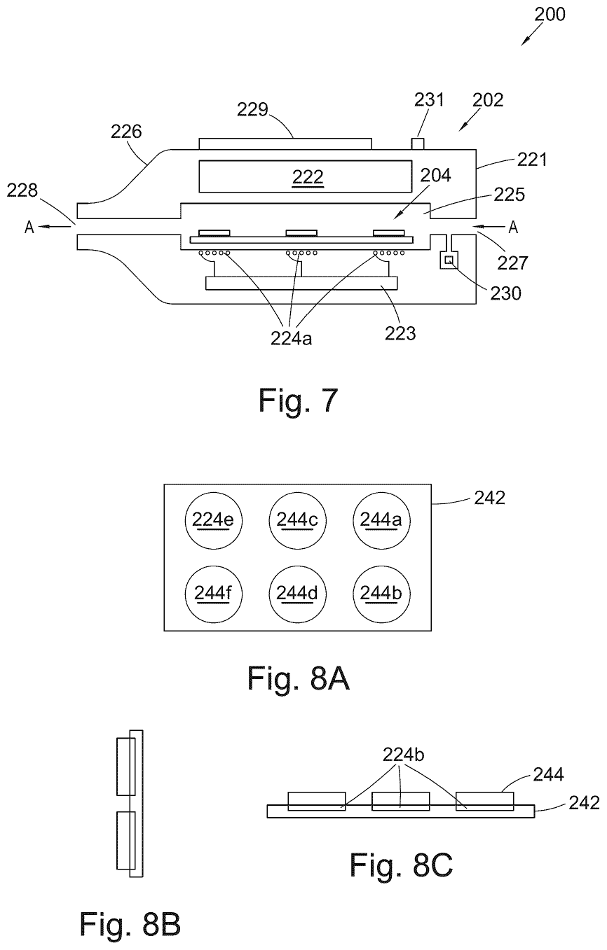

FIG. 7 is a cross-sectional view through a schematic representation of an aerosol provision system 200 in accordance with another embodiment of the disclosure. The aerosol provision system 200 includes components that are broadly similar to those described in relation to FIG. 1; however, the reference numbers have been increased by 200. For efficiency, the components having similar reference numbers should be understood to be broadly the same as their counterparts in FIGS. 1 and 2A to 2C unless otherwise stated.

The aerosol provision device 202 comprises an outer housing 221, a power source 222, control circuitry 223, induction work coils 224a, a receptacle 225, a mouthpiece end 226, an air inlet 227, an air outlet 228, a touch-sensitive panel 229, an inhalation sensor 230, and an end of use indicator 231.

The aerosol generating article 204 comprises a carrier component 242, aerosol generating material 244, and susceptor elements 244b, as shown in more detail in FIGS. 8A to 8C. FIG. 8A is a top-down view of the article 4, FIG. 8B is an end-on view along the longitudinal (length) axis of the article 4, and FIG. 8C is a side-on view along the width axis of the article 4.

FIGS. 7 and 8 represent an aerosol provision system 200 which uses induction to heat the aerosol generating material 244 to generate an aerosol for inhalation.

In the described implementation, the aerosol generating component 224 is formed of two parts; namely, induction work coils 224a which are located in the aerosol provision device 202 and susceptors 224b which are located in the aerosol generating article 204. Accordingly, in this described implementation, each aerosol generating component 224 comprises elements that are distributed between the aerosol generating article 204 and the aerosol provision device 202.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In the described implementation, the susceptors 224b are formed from an aluminum foil, although it should be appreciated that other metallic or electrically conductive materials may be used in other implementations. As seen in FIG. 8, the carrier component 242 comprises a number of susceptors 224b which correspond in size and location to the discrete portions of aerosol generating material 244 disposed on the surface of the carrier component 242. That is, the susceptors 224b have a similar width and length to the discrete portions of aerosol generating material 244.

The susceptors are shown embedded in the carrier component 242. However, in other implementations, the susceptors 224b may be placed on the surface of the carrier component 242.

The aerosol provision device 202 comprises a plurality of induction work coils 224a shown schematically in FIG. 7. The work coils 224a are shown adjacent the receptacle 225, and are generally flat coils arranged such that the rotational axis about which a given coil is wound extends into the receptacle 225 and is broadly perpendicular to the plane of the carrier component 242 of the article 204. The exact windings are not shown in FIG. 7 and it should be appreciated that any suitable induction coil may be used.

The control circuitry 223 comprises a mechanism to generate an alternating current which is passed to any one or more of the induction coils 224a. The alternating current generates an alternating magnetic field, as described above, which in turn causes the corresponding susceptor(s) 224b to heat up. The heat generated by the susceptor(s) 224b is transferred to the portions of aerosol generating material 244 accordingly.

As described above in relation to FIGS. 1 and 2A to 2C, the control circuitry 223 is configured to supply current to the work coils 224a in response to receiving signaling from the touch sensitive panel 229 or the inhalation sensor 230. Any of the techniques for selecting which heating elements 24 are heated by control circuitry 23 as described previously may analogously be applied to selecting which work coils 224a are energized (and thus which portions of aerosol generating material 244 are subsequently heated) in response to receiving signaling from the touch sensitive panel 229 or the inhalation sensor 230 by control circuitry 223 to generate an aerosol for user inhalation.

Although the above has described an induction heating aerosol provision system where the work coils 224a and susceptors 224b are distributed between the article 204 and device 202, an induction heating aerosol provision system may be provided where the work coils 224a and susceptors 224b are located solely within the device 202. For example, with reference to FIG. 7, the susceptors 224b may be provided above the induction work coils 224a and arranged such that the susceptors 224b contact the lower surface of the carrier component 242 (in an analogous way to the aerosol provision system 1 shown in FIG. 1).

Thus, FIG. 7 describes a more concrete implementation where induction heating may be used in an aerosol provision device 202 to generate aerosol for user inhalation to which the techniques described in the present disclosure may be applied.

Although the above has described a system in which an array of aerosol generating components 24 (e.g., heater elements) are provided to energize the discrete portions of aerosol generating material, in other implementations, the article 4 or an aerosol generating component 24 may be configured to move relative to one another. That is, there may be fewer aerosol generating components 24 than discrete portions of aerosol generating material 44 provided on the carrier component 42 of the article 4, such that relative movement of the article 4 and aerosol generating components 24 is required in order to be able to individually energize each of the discrete portions of aerosol generating material 44. For example, a movable heating element 24 may be provided within the receptacle 25 such that the heating element 24 may move relative to the receptacle 25. In this way, the movable heating element 24 can be translated (e.g., in the width and length directions of the carrier component 42) such that the heating element 24 can be aligned with respective ones of the discrete portions of aerosol generating material 44. This approach may reduce the number of aerosol generating components 42 required while still offering a similar user experience.

Although the above has described implementations where discrete, spatially distinct portions of aerosol generating material 44 are deposited on a carrier component 42, it should be appreciated that in other implementations the aerosol generating material may not be provided in discrete, spatially distinct portions but instead be provided as a continuous sheet of aerosol generating material 44. In these implementations, certain regions of the sheet of aerosol generating material 44 may be selectively heated to generate aerosol in broadly the same manner as described above. However, regardless of whether or not the portions are spatially distinct, the present disclosure described heating (or otherwise aerosolizing) portions of aerosol generating material 44. In particular, a region (corresponding to a portion of aerosol generating material) may be defined on the continuous sheet of aerosol generating material based on the dimensions of the heating element 24 (or more specifically a surface of the heating element 24 designed to increase in temperature). In this regard, the corresponding area of the heating element 24 when projected onto the sheet of aerosol generating material may be considered to define a region or portion of aerosol generating material. In accordance with the present disclosure, each region or portion of aerosol generating material may have a mass no greater than 20 mg, however the total continuous sheet may have a mass which is greater than 20 mg.

Although the above has described implementations where the device 2 can be configured or operated using the touch-sensitive panel 29 mounted on the device 2, the device 2 may instead be configured or controlled remotely. For example, the control circuitry 23 may be provided with a corresponding communication circuitry (e.g., Bluetooth) which enables the control circuitry 23 to communicate with a remote device such as a smartphone. Accordingly, the touch-sensitive panel 29 may, in effect, be implemented using an App or the like running on the smartphone. The smartphone may then transmit user inputs or configurations to the control circuitry 23, and the control circuitry 23 may be configured to operate on the basis of the received inputs or configurations.

Although the above has described implementations in which an aerosol is generated by energizing (e.g., heating) aerosol generating material 44 which is subsequently inhaled by a user, it should be appreciated in some implementations that the generated aerosol may be passed through or over an aerosol modifying component to modify one or more properties of the aerosol before being inhaled by a user. For example, the aerosol provision device 2, 202 may comprise an air permeable insert (not shown) which is inserted in the airflow path downstream of the aerosol generating material 44 (for example, the insert may be positioned in the outlet 28). The insert may include a material which alters any one or more of the flavor, temperature, particle size, nicotine concentration, etc. of the aerosol as it passes through the insert before entering the user's mouth. For example, the insert may include tobacco or treated tobacco. Such systems may be referred to as hybrid systems. The insert may include any suitable aerosol modifying material, which may encompass the aerosol generating materials described above.

Although it has been described above that the heating elements 24 are arranged to provide heat to a portion of aerosol generating material at an operational temperature at which aerosol is generated from the portion of aerosol generating material, in some implementations, the heating elements 24 are arranged to pre-heat portions of the aerosol generating material to a pre-heat temperature (which is lower than the operational temperature). At the pre-heat temperature, a lower amount or no aerosol is generated when the portion is heated at the pre-heat temperature. However, a lower amount of energy is required to raise the temperature of the aerosol generating material from the pre-heat temperature to the operational temperature. This may be particularly suitable for relatively thicker portions of aerosol generating material, e.g., having thicknesses above 400 μm, which require relatively larger amounts of energy to be supplied in order to reach the operational temperature. In such implementations, the energy consumption (e.g., from the power source 22) may be comparably higher, however.

Although the above has described implementations in which the aerosol provision device 2 comprises an end of use indicator 31, it should be appreciated that the end of use indicator 31 may be provided by another device remote from the aerosol provision device 2. For example, in some implementations, the control circuitry 23 of the aerosol provision device 2 may comprise a communication mechanism which allows data transfer between the aerosol provision device 2 and a remote device such as a smartphone or smartwatch, for example. In these implementations, when the control circuitry 23 determines that the article 4 has reached its end of use, the control circuitry 23 is configured to transmit a signal to the remote device, and the remote device is configured to generate the alert signal (e.g., using the display of a smartphone). Other remote devices and other mechanisms for generating the alert signal may be used as described above.

In some implementations, the article 4 may comprise an identifier, such as a readable bar code or an RFID tag or the like, and the aerosol provision device 2 comprises a corresponding reader. When the article is inserted into the receptacle 25 of the device 2, the device 2 may be configured to read the identifier on the article 4. The control circuitry 23 may be configured to either recognize the presence of the article 4 (and thus permit heating or reset an end of life indicator) or identify the type or the location of the portions of the aerosol generating material relative to the article 4. This may affect which portions the control circuitry 23 aerosolizes or the way in which the portions are aerosolized, e.g., via adjusting the aerosol generation temperature or heating duration. Any suitable technique for recognizing the article 4 may be employed.

In addition, when the portions of aerosol generating material are provided on a carrier component 42, the portions may, in some implementations, include weakened regions, e.g., through holes or areas of relatively thinner aerosol generating material, in a direction approximately perpendicular to the plane of the carrier component 42. This may be the case when the hottest part of the aerosol generating material is the area directly contacting the carrier component (in other words, in scenarios where the heat is applied primarily to the surface of the aerosol generating material that contacts the carrier component 42). Accordingly, the through holes may provide channels for the generated aerosol to escape and be released to the environment/the air flow through the device 2 rather than causing a potential build-up of aerosol between the carrier component 42 and the aerosol generating material 44. Such build-up of aerosol can reduce the heating efficiency of the system as the build-up of aerosol can, in some implementations, cause a lifting of the aerosol generating material from the carrier component 42 thus decreasing the efficiency of the heat transfer to the aerosol generating material. Each portion of aerosol generating material may be provided with one of more weakened regions as appropriate.

Thus, there has been described an aerosol provision system for generating aerosol from an aerosol generating material. The system comprises one or more portions of solid aerosol generating material, where each portion of solid aerosol generating material having a mass no greater than 20 mg. The system further comprises one or more aerosol generating components and control circuitry configured to supply power to the one or more aerosol generating components, wherein the control circuitry is configured to cause heating of at least one of the one or more portions of aerosol generating material using the one or more aerosol generating components at an operational temperature at which aerosol is generated from the at least one of the one or more portions of aerosol generating material of no greater than 350° C. for a continuous duration of no greater than 10 seconds. Also provided is an aerosol provision device and an method for aerosolizing material.

While the above described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments of the disclosure may be practiced. The advantages and features of the disclosure are of a representative sample of embodiments only, and are not exhaustive or exclusive. They are presented only to assist in understanding and to teach the subject matter of the disclosure. It is to be understood that advantages, embodiments, examples, functions, features, structures, or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other embodiments not presently claimed, but which may be claimed in future.

Aspects of the present disclosure may be summarized by the following numbered clauses:
1. An aerosol provision system for generating aerosol from an aerosol generating material, the system comprising:
a plurality of portions of aerosol generating material, each portion of aerosol generating material being substantially the same as one another;
one or more aerosol generating components; and
control circuitry configured to supply power to the one or more aerosol generating components,
wherein the control circuitry is configured to sequentially aerosolize each of the plurality of portions of aerosol generating material such that substantially the same amount of aerosol is generated from each of the individual portions of aerosol generating material for a given activation time of the one or more aerosol generating components.
2. The aerosol provision system of clause 1, wherein system comprises a plurality of aerosol generating components, wherein each of the aerosol generating components are substantially the same as one another.
3. The aerosol provision system of clause 1 or 2, wherein the control circuitry is configured to receive a signal signifying a user's intent to generate aerosol, and in response to receiving the signal, cause aerosolization of a first portion of the aerosol generating material.
4. The aerosol provision system of clause 3, wherein the control circuitry is configured to receive a subsequent signal signifying a user's intent to generate aerosol after aerosolizing the first portion of aerosol generating material, and in response thereto, to cause aerosolization of a second portion of the aerosol generating material.
5. The aerosol provision system of any of the preceding clauses, wherein the one or more aerosol generating components are heating elements, and wherein the heating elements are substantially the same as one another.
6. The aerosol provision system of clause 5, wherein the control circuitry is configured to heat each of the plurality of portions of aerosol generating material according to the same temperature profile.
7. The aerosol provision system of clause 5 or 6, wherein the control circuitry is configured to begin heating each of the plurality of portions of aerosol generating material when the heating element is substantially at ambient temperature or at a preheating temperature.
8. The aerosol provision system of any of clauses 5 to 7, wherein the system comprises a plurality of heating elements arranged in a pattern, and wherein the control circuitry is configured to select a heating element in the pattern that is spatially further away from the current heating element than the closest heating element in the pattern as the next heating element in the sequence.
9. The aerosol provision system of any preceding clause, wherein the aerosol generating material is an amorphous solid.
10. The aerosol provision system of clause 9, wherein the amorphous solid comprises a gelling agent in an amount of from about 5 wt % to about 40 wt %, tobacco extract in an amount of from about 30 wt % to about 60 wt % and aerosol generating agent in an amount of from about 10 wt % to about 50 wt %.
11. The aerosol provision system of any preceding clause, wherein each portion of aerosol generating material has a mass no greater than 20 mg.
12. The aerosol provision system of any preceding clause, wherein each portion of aerosol generating material has a thickness of between 0.05 mm to 0.40 mm.
13. The aerosol provision system of any preceding clause, wherein each portion of aerosol generating material comprises less than 15 mg of water.
14. An aerosol provision device for generating aerosol from an aerosol generating material, the device comprising:
one or more aerosol generating components configured to aerosolize a plurality of portions of aerosol generating material, each portion of aerosol generating material being substantially the same as one another; and
control circuitry configured to supply power to the one or more aerosol generating components,
wherein the control circuitry is configured to sequentially aerosolize each of the plurality of portions of aerosol generating material such that substantially the same amount of aerosol is generated from each of the individual portions of aerosol generating material for a given activation time of the one or more aerosol generating components.
15. An aerosol generating article comprising aerosol generating material, the aerosol generating article comprising a plurality of portions of the aerosol generating material, wherein each of the portions of the aerosol generating material are substantially the same as one on another.
16. A method for generating aerosol from a plurality of portions of aerosol generating material using one or more aerosol generating components, the method comprising:
aerosolizing a first portion of aerosol generating material to generate a first amount of aerosol from the second portion of aerosol generating material; and
thereafter, aerosolizing a second portion of aerosol generating material to generate a second amount of aerosol from the second portion of aerosol generating material,
wherein each of the first and second portions of aerosol generating material are substantially the same as one another, and wherein the first amount of aerosol is substantially the same as the second amount of aerosol.
17. An aerosol provision system for generating aerosol from an aerosol generating material, the system comprising:
a plurality of portions of aerosol generating material, each portion of aerosol generating material being substantially the same as one another;
one or more aerosol generating means; and
control means configured to supply power to the one or more one or more aerosol generating means,
wherein the control means is configured to sequentially aerosolize each of the plurality of portions of aerosol generating material such that substantially the same amount of aerosol is generated from each of the individual portions of aerosol generating material for a given activation time of the one or more aerosol generating means.

1. An aerosol provision system for generating aerosol from an aerosol generating material, the system comprising:
one or more portions of solid aerosol generating material, each portion of solid aerosol generating material having a mass no greater than 20 mg, and comprising aerosol generating agent in an amount of from about 5 wt % to 80 wt % and gelling agent in an amount of from about 1 wt % to 60 wt %, wherein these weights are calculated on a dry weight basis, and less than 15 mg water;
one or more aerosol generating components; and
control circuitry configured to supply power to the one or more aerosol generating components,
wherein the control circuitry is configured to cause heating of at least one of the one or more portions of aerosol generating material using the one or more aerosol generating components at an operational temperature at which aerosol is generated from the at least one of the one or more portions of aerosol generating material of no greater than 350° C. for a continuous duration of no greater than 10 seconds.

2. The aerosol provision system of claim 1, wherein:
(A) the control circuitry is configured to cause heating of the at least one of the one or more portions of aerosol generating material at the operational temperature in response to receiving an input indicative of a user's desire to inhale an aerosol; or
(B) the control circuitry is configured to cease causing heating of the at least one of the one or more portions of aerosol generating material at the operational temperature in response to determining the input indicative of the user's desire to inhale an aerosol is no longer being input; or
(C) the control circuitry is configured to cause heating of the at least one of the one or more portions of aerosol generating material using the one or more aerosol generating components for a duration selected from the group comprising: between 1 to 9 seconds, between 1.5 to 7 seconds, and between 2 to 5 seconds; or
(D) the control circuitry is configured to cause heating of at least one of the one or more portions of aerosol generating material using the one or more aerosol generating components at an operational temperature selected from the group comprising: between 150° C. to 350° C., between 180° C. to 320° C., and between 220° C. to 300° C.; or
(E) the control circuitry is configured to cause heating of the at least one of the one or more portions of aerosol generating material using the one or more aerosol generating components at a preheat temperature which is lower than the operational temperature.

3. The aerosol provision system of claim 1, wherein the mass of each portion of solid aerosol generating material, the thickness of each portion of solid aerosol generating material, and the operational temperature are selected so as to generate an aerosol having a desired amount of one or more constituent components when heated at the operational temperature for a predetermined time not exceeding 10 seconds.

4. The aerosol provision system of claim 1, wherein the system comprises a plurality of portions of aerosol generating material, and wherein the control circuitry is configured to cause heating of each of the plurality of portions of aerosol generating material using the one or more aerosol generating components at an operational temperature of no greater than 350° C. for a duration of no greater than 10 seconds; and
wherein the control circuitry is configured to cause sequential heating of at least two of the plurality of portions of aerosol generating material in response to receiving sequential inputs indicative of a user's desire to inhale an aerosol.

5. The aerosol provision system of claim 4, wherein each of the plurality of portions of aerosol generating material are substantially the same as one another, wherein the control circuitry is configured to sequentially aerosolize each of the plurality of portions of aerosol generating material such that substantially the same amount of aerosol is generated from each of the portions of aerosol generating material for a given activation time of the one or more aerosol generating components.

6. The aerosol provision system of claim 1, wherein the system comprises a plurality of aerosol generating components, wherein each of the aerosol generating components is substantially the same as one another and the control circuitry is configured to cause heating of each of the plurality of portions of aerosol generating material according to the same temperature profile.

7. The aerosol provision system of claim 1, wherein the system comprises a plurality of aerosol generating components arranged in a pattern, and wherein the control circuitry is configured to select an aerosol generating component in the pattern that is spatially further away from the current aerosol generating component than the closest aerosol generating component in the pattern as the next heating element in the sequence.

8. The aerosol provision system of claim 1, wherein the control circuitry is configured to cause individual heating of at least one of the one or more portions of aerosol generating material.

9. The aerosol provision system of claim 1, further comprising one or more user input mechanisms for receiving a user input.

10. The aerosol provision system of claim 9, wherein the one or more user input mechanisms comprises a first user input mechanism and a second user input mechanism.

11. The aerosol provision system of claim 10, wherein the first user input mechanism is configured to be touched by a user when receiving a user input from the user.

12. The aerosol provision system of claim 11, wherein the first user input mechanism comprises a touch-sensitive panel.

13. The aerosol provision system of claim 10, wherein the second user input mechanism comprises an inhalation sensor.

14. The aerosol provision system of claim 10, wherein the control circuitry is configured to supply power to the one or more aerosol generating components in response to detecting signalling from one or both of the first user input mechanism and second user input mechanism.

15. The aerosol provision system of claim 14, wherein the one or more aerosol generating components comprises a plurality of aerosol generating components, and the control circuitry is configured to sequentially supply power to one or more of the plurality of aerosol generating components in response to detecting signalling from one or both of the first user input mechanism and second user input mechanism.

16. The aerosol provision system of claim 15, wherein the control circuitry is configured to sequentially supply power to each of the plurality of aerosol generating components in response to detecting signalling from one or both of the first user input mechanism and second user input mechanism.

17. The aerosol provision system of claim 15, wherein the one or more portions of aerosol generating material comprise a plurality of portions of aerosol generating material, and wherein each aerosol generating component is arranged to align with a corresponding portion of aerosol generating material.

18. The aerosol provision system of claim 15, wherein the plurality of aerosol generating components comprises a plurality of heating elements.

19. The aerosol provision system of claim 18, wherein the one or more user input mechanisms are configured to permit a user to individually select which of the plurality of heating elements to activate when the signalling from one or both of the first user input mechanism and second user input mechanism is detected.

20. The aerosol provision system of claim 18, wherein the one or more user input mechanisms are configured to permit a user to set a power level to be supplied to each of the plurality of heating elements when the signalling from one or both of the first user input mechanism and second user input mechanism is detected.
